(19) United States
(12) Patent Application Publication
(10) Pub. No.: US 2026/0320884 A1
(43) Pub. Date: Oct. 15, 2026

(54) DEVICE AND METHOD FOR VIDEO EDITING BASED ON NOISE DILUTION

(71) Applicant: KOREA ADVANCED INSTITUTE OF SCIENCE AND TECHNOLOGY, Daejeon (KR)

(72) Inventors: Changdong YOO, Daejeon (KR); Sunjae YOON, Daejeon (KR); Gwanhyeong KOO, Daejeon (KR)

(21) Appl. No.: 19/407,107

(22) Filed: Dec. 3, 2025

(30) Foreign Application Priority Data
Apr. 14, 2025 (KR) 10-2025-0047931

(51) Int. Cl. G06T 13/00; G06T 5/60; G06T 5/70; G06T 11/00

(52) U.S. Cl. CPC G06T 13/00; G06T 5/60; G06T 5/70; G06T 11/00; G06T 2207/10016

(57) ABSTRACT

A method for video editing based on noise dilution by at least one processor comprises: separating initial latent noise of an input video into visual noise and Gaussian noise using an adaptive spectral filter designed to extract video components according to a frequency distribution of the input video; determining an editing region to be edited in the input video using the input video and input text; generating diluted visual noise in which visual noise in the editing region is diluted by blending Gaussian noise and the visual noise; and generating dilutional latent noise by recombining Gaussian noise separated from the initial latent noise and the diluted visual noise.

### CROSS-REFERENCE TO RELATED APPLICATION

This application claims priority to and the benefit of Korean Patent Application No. 10-2025-0047931 filed with the Korean Intellectual Property Office on Apr. 14, 2025, the entire contents of which are incorporated herein by reference.

### BACKGROUND

### (a) Field

The present disclosure relates to a video editing.

### (b) Description of the Related Art

Diffusion model-based video editing may perform editing with high fidelity and precise text alignment for input videos. However, since editing is performed while maintaining structural layouts of the input videos, it is limited to rigid editing such as style transfer and object overlay.

Therefore, non-rigid editing such as changing of object motion may not properly generate video meeting user requirements or may generate unnatural motion. In this way, the conventional video editing has limitations in editing that requires structural changes, such as changing a walking object into a running object.

### SUMMARY

The present disclosure attempts to provide a noise dilution-based video editing device and method.

The present disclosure attempts to provide a device and method for generating videos arranged on a target prompt with no limits of a visual structure by alleviating a visual structure included in initial latent noise of an input video through noise dilution.

An embodiment of the present disclosure provides a method for video editing based on noise dilution by at least one processor including: separating initial latent noise of an input video into visual noise and Gaussian noise using an adaptive spectral filter designed to extract video components according to a frequency distribution of the input video; determining an editing region to be edited in the input video using the input video and input text; generating diluted visual noise by blending Gaussian noise and the visual noise of the editing region; and generating dilutional latent noise by recombining Gaussian noise separated from the initial latent noise and the diluted visual noise.

The editing region may be determined by an editing guidance mask obtained through cross-attention between the input text and the input video.

The determining the editing region may include: generating editing guidance masks for editing reference words extracted from the input text, and generating the editing guidance mask for guiding the editing region by combining the editing guidance masks of the entire editing reference words.

The determining the editing region may include: combining the editing guidance masks of the entire editing reference words by adjusting influences of a rigid editing mask and a non-rigid editing mask.

The generating the diluted visual noise may include: generating the diluted visual noise by the Gaussian noise blending for blending Gaussian noise added to the editing region and visual noise added to the non-editing region.

The method may further include: generating an edited video by denoising the dilutional latent noise according to the input text.

The method may further include: providing the dilutional latent noise to a backward process of diffusion model-based video editing.

Another embodiment of the present disclosure provides a method for video editing based on noise dilution by at least one processor, including: obtaining an original video and target prompt text; generating initial latent noise by injecting Gaussian noise into the original video; separating the initial latent noise into visual noise and Gaussian noise using an adaptive spectral filter of the original video; determining an editing region to be edited in the original video using the original video and the target prompt text; generating diluted visual noise by diluting visual noise of the editing region; generating dilutional latent noise by recombining Gaussian noise separated from the initial latent noise and the diluted visual noise; and generating an edited video by denoising the dilutional latent noise according to the target prompt text.

The adaptive spectral filter may be implemented to extract video components according to frequency distribution of the original video.

The editing region may be determined by the editing guidance mask obtained through the cross-attention between the target prompt text and the original video.

The determining the editing region may include: generating editing guidance masks for editing reference words extracted from the target prompt text, and generating the editing guidance mask for guiding the editing region by combining the editing guidance masks of the entire editing reference words.

The determining the editing region may include: combining the editing guidance masks of the entire editing reference words by adjusting influences of a rigid editing mask and a non-rigid editing mask.

The generating the diluted visual noise may include: generating the diluted visual noise by diluting visual noise of the editing region according to a blending of Gaussian noise and maintaining visual noise of the non-editing region.

Another embodiment of the present disclosure provides a device including: at least one memory; and at least one processor for performing instructions stored in the at least one memory, wherein the processor is configured to separate initial latent noise of the input video into visual noise and Gaussian noise using an adaptive spectral filter designed to extract video components according to frequency distribution of an input video; determine an editing region to be edited in the input video using the input video and input text; generate diluted visual noise by blending Gaussian noise and the visual noise of the editing region; and generate dilutional latent noise by recombining Gaussian noise separated from the initial latent noise and the diluted visual noise.

Another embodiment of the present disclosure provides a computer program stored in a computer-readable storage medium including instructions for causing at least one processor to execute to: separate initial latent noise of an input video into visual noise and Gaussian noise using an adaptive spectral filter for extracting video components according to frequency distribution of the input video; determine an editing region to be edited in the input video using the input video and input text; generate diluted visual noise by blending Gaussian noise and the visual noise of the editing region; and generate dilutional latent noise by recombining Gaussian noise separated from the initial latent noise and the diluted visual noise.

According to the present disclosure, the video arranged on the target prompt without limit of visual structures may be generated through noise dilution.

According to the present disclosure, the non-rigid editing such as a change of motion may be precisely and dynamically performed, and the rigid editing maintaining the visual structure like the style transfer may be naturally and creatively performed.

According to the present disclosure, the video edited as needed by the user may be generated.

According to the present disclosure, performance of the existing video editing system may be improved by applying the dilutional noise initialization (DNI) framework to various types of video editing systems.

### BRIEF DESCRIPTION OF THE DRAWINGS

FIG. 1 shows a diffusion model-based video editing.

FIG. 2 shows editing results according to conventional video editing.

FIG. 3 shows a noise dilution-based video editing device according to an embodiment.

FIG. 4 shows spectrum characteristics of initial latent noise according to an embodiment.

FIG. 5 shows noise separation according to an embodiment.

FIG. 6 shows a noise dilution according to an embodiment.

FIG. 7 shows non-rigid editing result to which a dilutional noise initialization (DNI) framework according to an embodiment is applied.

FIG. 8 shows rigid editing result to which a dilutional noise initialization (DNI) framework according to an embodiment is applied.

FIG. 9 and FIG. 10 show text alignment sensitivity analysis caused by an editing guidance mask according to an embodiment.

FIG. 11 shows a flowchart on a noise dilution method according to an embodiment.

FIG. 12 shows a flowchart on a noise dilution-based video editing method according to an embodiment.

FIG. 13 shows a hardware schematic diagram on a computing device according to an embodiment.

### DETAILED DESCRIPTION OF THE EMBODIMENTS

In the following detailed description, only certain exemplary embodiments of the present disclosure have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive, and like reference numerals designate like elements throughout the specification.

In the description, reference numerals and names are arbitrarily shown for understanding and ease of description, but the present disclosure is not limited thereto.

Unless explicitly described to the contrary, the word “comprise”, and variations such as “comprises” or “comprising”, will be understood to imply the inclusion of stated elements but not the exclusion of any other elements. In addition, the terms “-er”, “-or”, and “module” described in the specification mean units for processing at least one function and operation, and may be implemented by hardware components or software components, and combinations thereof.

The device according to the present disclosure is a computing device configured and connected to perform the operations of the present disclosure by allowing at least one processor to execute instructions. The computer program may include instructions that cause a processor to perform the operations of the present disclosure and may be stored in a non-transitory computer readable storage medium. The computer program may be downloaded through the network or may be sold as products.

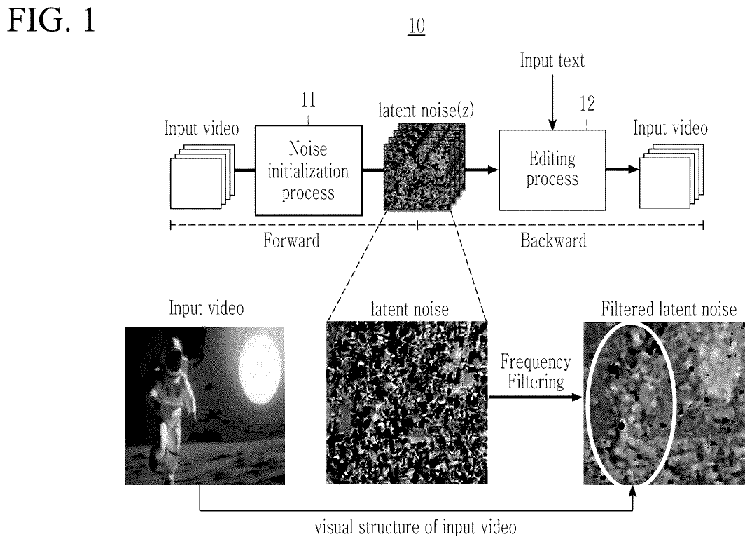

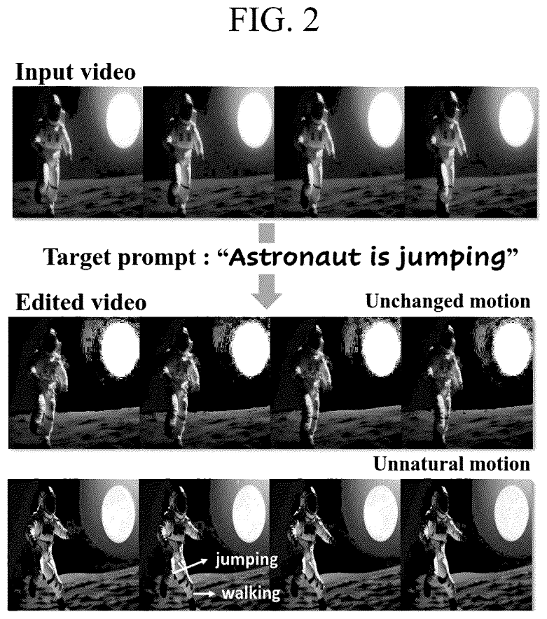

FIG. 1 shows a diffusion model-based video editing, and FIG. 2 shows editing results according to conventional video editing.

Referring to FIG. 1, video editing aims to modify specific properties of an input video (or an original video) according to the user's requirements. Recently, a technology for editing input videos with high fidelity and precise text alignment using a diffusion model instead of a generation model has been gaining attention. The diffusion model-based video editing method 10 includes a forward process adding noise and a backward process removing noise to generate desired outputs.

The diffusion model-based video editing method 10 may prepare latent noise (z) by adding Gaussian noise to the input video using a noise initialization process 11, and may generate an edited video by denoising the latent noise according to the input text using an editing process 12.

The diffusion model-based video editing method 10 allows users to edit video into desired scenes, but is limited to rigid editing such as style transfer and object overlay. Therefore, non-rigid editing such as the change of object motion may not properly generate a video that meets user requirements or may generate unnatural motion.

Referring to FIG. 2, when a target prompt of ‘Astronaut is jumping’ is input, a jumping motion that is the target operation is not generated (unchanged motion), or a walking motion of the original video and the jumping motion that is the target operation are blended to generate an unnatural motion.

Referring to FIG. 1, it may be confirmed that quality deterioration of non-rigid editing, such as the change of object motion, comes from latent noise. That is, latent noise is generated by gradually adding Gaussian noise to the input video, but the visual structure/video layout of the input video still remains in the latent noise, which is assumed to be Gaussian noise. The visual structure remaining in latent noise may be checked through frequency filtering. The visual structure remaining in latent noise facilitates rigid editing, but conversely, it functions as an obstacle that restricts non-rigid editing.

To address the issues, the present disclosure generating the video edited based on input text without constraints on the input video layout by alleviating the visual structure included in latent noise through noise dilution will now be described.

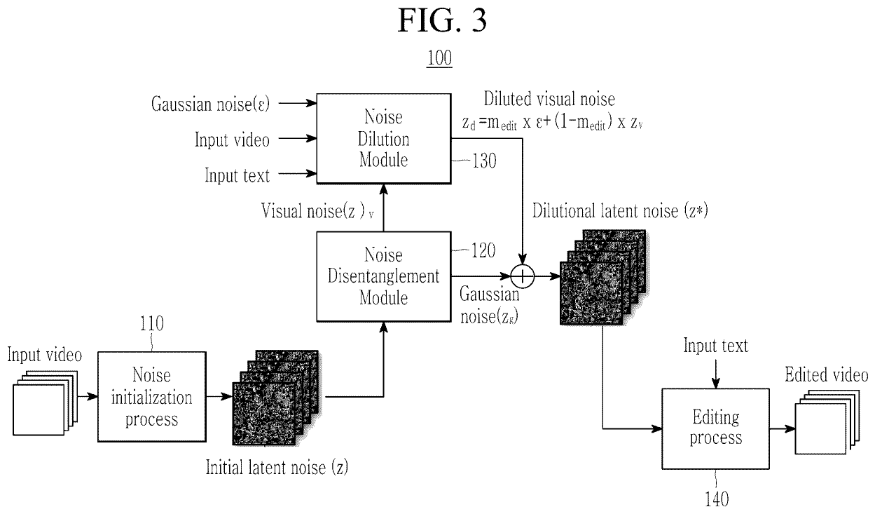

FIG. 3 shows a noise dilution-based video editing device according to an embodiment.

Referring to FIG. 3, a noise dilution-based video editing device (simply referred to as device) 100 may be implemented to inject noise into the input video and remove the noise according to input text to generate an edited video. The device 100 is implemented to perform video editing using dilutional latent noise z* obtained through noise dilution, instead of performing video editing using the initial latent noise (z). The device 100 may be a computing device including a memory storing instructions causing the present disclosure to be performed, and at least one processor implemented to execute the instructions to perform the method of the present disclosure. The computer program includes instructions that cause at least one processor to execute the present disclosure.

In the present disclosure, noise dilution indicates generating dilutional latent noise (z*) that is closer to Gaussian noise than the initial latent noise (z). The noise dilution method may be variable, but when the Gaussian noise is additionally injected into the entire video region, the visual structure of the entire video will be diluted, as a result of which the quality of the edited video generated by removing latent noise may be deteriorated. Therefore, the present disclosure identifies the region to be edited, particularly the non-rigid editing region, and performs noise dilution on the editing region. The dilutional latent noise (z*) having alleviated the visual structure of the input video is used, so the editing corresponding to the input text may be performed dynamically without being restricted by the input video structure. A framework for generating dilutional latent noise (z*) from initial latent noise (z) may be referred to as the dilutional noise initialization (DNI) framework.

The device 100 may include a noise initialization module 110, a noise disentanglement module 120, a noise dilution module 130, and an editing module 140 injecting noise into the input video. Each module is a function module distinguished to describe the operation of the device 100, and does not need to be physically or logically distinguished. The noise initialization module 110 and the editing module 140 may correspond to a forward process and a backward process of the diffusion model, and may learn to generate edited videos through noise addition and denoising according to the training method of the diffusion model. The noise disentanglement module 120 and the noise dilution module 130 are a dilutional noise initialization (DNI) framework, which may be applied to the existing video editing system implemented as in FIG. 1.

The noise initialization module 110 may generate initial latent noise (z) of the input video by adding Gaussian noise to the input video. The initial latent noise (z) may be obtained through an inverse denoising method such as DDIM (denoising diffusion implicit model) inversion. The frame converted to initial latent noise may be referred to as an initial latent noise frame.

The noise disentanglement module 120 may separate the initial latent noise (z) of the input video into visual noise (zᵥ) related to the visual structure and Gaussian noise (z_{g}). The initial latent noise frame may be separated into a visual noise frame including visual noise and a Gaussian noise frame including Gaussian noise. The initial latent noise (z) generated by gradually injecting Gaussian noise into the input video is close to Gaussian noise, but input video components remain so it is necessary to separate the visual noise to be diluted from the initial latent noise (z). The separated visual noise (zᵥ) is diluted to be close to Gaussian noise in the noise dilution module 130 and then recombines with the separated Gaussian noise (Z_{g}).

The noise disentanglement module 120 may use an adaptive spectral filter (ASF) on the input video to separate the visual noise and Gaussian noise included in the initial latent noise (z). The adaptive spectral filter may be designed to extract input video components by capturing the frequency range of the input video according to the frequency distribution of the input video.

The noise dilution module 130 performs a noise dilution process for visual noise (zv). By diluting the visual noise of the editing region in the input video, the editing region may be dynamically modified in the editing module 140, and the video quality may be guaranteed by maintaining the visual components of the non-editing region. To this end, the noise dilution module 130 may determine the editing region in the input video based on the input text, and may dilute the visual noise in the editing region by adding Gaussian noise (ε) to the editing region of the visual noise frame.

The editing region may be determined by the semantic relationship between the input video and the input text, and may be determined through an attention map obtained based on cross-attention between the input text and the input video. For example, the cross-attention model may be designed using various models, such as the UNet. The editing region may be determined based on the similarity between input text features and video features, and the similarity may be calculated at the grid level where each frame is divided.

The editing region may be guided by an editing guidance mask (m_{edit}). As there are editing reference words that require structural changes and words that do not among the words in the input text, the final editing guidance mask may be generated by appropriately combining the editing guidance masks obtained from the words.

The noise dilution module 130 may identify an editing region (e.g., the astronaut's leg region) that requires a structure change due to input text (e.g., ‘Astronaut is jumping’) and may dilute the visual noise of the editing region through Gaussian noise blending. The input video structure is alleviated through visual noise dilution, allowing dynamic motion changes in the editing region.

Noise dilution methods for editing regions may vary. For example, Gaussian noise blending for visual noise may be performed using the editing guidance mask m_{edit} and the non-editing guidance mask (1-m_{edit}) that is its inverted version, as in Equation 1. Gaussian noise (ε) may be added to the editing region identified by the editing guidance mask m_{edit}, while the visual noise (zᵥ) of the non-editing region may be maintained. That is, when Gaussian noise (ε) is filled through the editing guidance mask and visual noise is filled through the non-editing guidance mask, adaptively diluted visual noise (z_{d}) may be output.

$${z}_{d} = {m}_{edit} \times ε + ( 1 - {m}_{edit} ) \times {z}_{v} \qquad ( Equation 1 )$$

The visual noise in the editing region may be diluted by adding Gaussian noise (ε) to the editing region of the visual noise (z_{d}).

Dilutional latent noise (z*) is synthesized by combining Gaussian noise (z_{g}) separated from the noise disentanglement module 120 and visual noise (z_{d}) adaptively diluted in the noise dilution module 130. That is, Gaussian noise (z_{g}) separated from the initial latent noise and diluted visual noise (z_{d}) are recombined and are used for video editing. The dilutional latent noise (z*) serves to reduce the rigidity of the visual structure in the editing region while preserving the visual structure in the non-editing region.

The editing module 140 may generate an edited video by removing noise from dilutional latent noise according to the input text. The editing module 140 may be implemented based on a diffusion model, and as in equation 2, instead of the initial latent noise (z), it may receive diluted dilutional latent noise (z*) of the visual noise of the editing region, and may denoise it according to the input text T, and may output the edited video V_{edit}.

$${V}_{edit} = Denoise ( {z}^{*} , T ) \qquad ( Equation 2 )$$

Recent video editing technologies are divided into a tuning-based model and a tuning-free model, and the dilutional noise initialization (DNI) framework of the present disclosure may be applied irrespective of models. The tuning-based model may cause overfitting because it trains a diffusion model based on the input video. Therefore, if the training video is too closely stuck when inferring editing, unnatural editing may be generated. In the tuning-based models, dilutional latent noise may be used to reduce excessive reliance on the initial visual structure and better adapt to the target prompt, thereby improving naturalness, fidelity, and consistency. The tuning-free model has excellent consistency, but is less responsive to target prompts and relies on the input video structure of the initial latent noise, making it suitable for rigid editing. By using dilutional latent noise in the tuning-free model, the dependence on the input video structure may be adaptively reduced and the efficiency of editing may be improved.

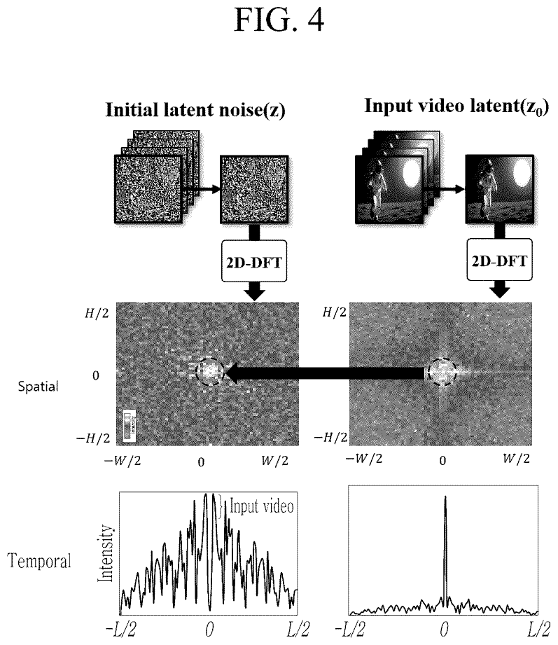

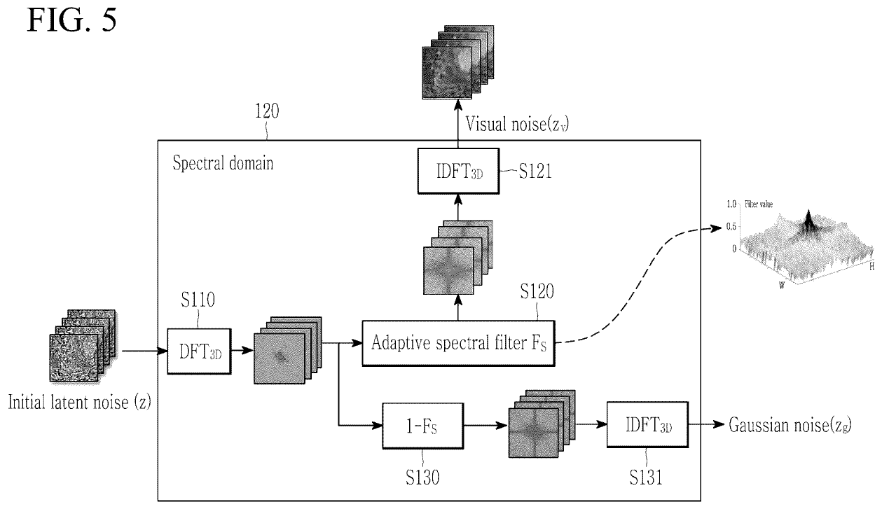

FIG. 4 shows spectral characteristics of initial latent noise according to an embodiment, and FIG. 5 shows noise separation according to an embodiment.

Referring to FIG. 4, the spectral characteristics of the initial latent noise (z) show that the low frequency bandwidth of the initial latent noise (z) has a distribution similar to that of the input video (z₀) in both spatial and temporal frequencies. Therefore, the input video configuration may be obtained by applying a low pass filter. However, the low pass filter loses high frequency components of the input video and causes each input video to correspond to a different frequency. Therefore, the present disclosure has the feature of separating the input video components by designing an adaptive spectral filter (ASF) adaptively responding to frequency changes in the input video. The adaptive spectral filter may be built based on the frequency spectrum of the input video (z₀) to appropriately capture the frequency range of the input video.

The noise disentanglement module 120 may generate an adaptive spectral filter depending on the input video. The noise disentanglement module 120 may obtain the frequency distribution of the input video and may generate the adaptive spectral filter by normalizing the frequency distribution of the input video to a value between 0 and 1. The frequency distribution of the input video may be obtained through discrete Fourier transform (DTF). The adaptive spectral filter Fₛ, which varies depending on the input video, may be defined as in Equation 3.

$${F}_{s} = {Norm}_{min - max} ( {DFT}_{3 D} ( {z}_{0} ) ) ∈ {R}^{W \times H \times L \times C} \qquad ( Equation 3 )$$

Here, z₀ is the input video, and W, H, L, and C are the width, height, length, and channel of the input video. The DFT_{3D} is a 3-dimensional discrete Fourier transform, and Normₘᵢₙ₋ₘₐₓ is a min-max normalized function for scaling between 0 and 1.

By using the adaptive spectral filter Fₛ filtering the frequency components of the input video, the initial latent noise (z) may be separated into visual noise (zᵥ) and Gaussian noise (z_{g}) as in Equation 4 and Equation 5. In Equation 4 and Equation 5, IDFT_{3D} is the inverse DFT_{3D}, and ⊙ is the product for respective components.

$${z}_{v} = {IDFT}_{3 D} ( {F}_{s} ⊙ {DFT}_{3 D} ( z ) ) \qquad ( Equation 4 )$$

$${z}_{g} = {IDFT}_{3 D} ( ( 1 - {F}_{s} ) ⊙ {DFT}_{3 D} ( z ) ) \qquad ( Equation 5 )$$

Referring to FIG. 5, the noise disentanglement module 120 may separate the visual noise (zᵥ) and the Gaussian noise (z_{g}) of each frame in the frequency domain of the initial latent noise (z).

The noise disentanglement module 120 applies a 3-dimensional discrete Fourier transform DFT_{3D} to the initial latent noise (z) of each frame to obtain the noise frequency DFT_{3D}(z) transformed into the frequency domain (S110).

The noise disentanglement module 120 separates the visual noise in the frequency domain by multiplying the noise frequency DFT_{3D}(z) by the adaptive spectral filter Fₛ filtering the frequency component of the input video (S120). The noise disentanglement module 120 may obtain visual noise (zᵥ) by applying the 3-dimensional inverse discrete Fourier transform IDFT_{3D} to the visual noise in the frequency domain (S121). The adaptive spectral filter Fₛ is generated to filter the input video components based on the frequency distribution of the input video.

The noise disentanglement module 120 separates the Gaussian noise in the frequency domain by multiplying the noise frequency DFT_{3D}(z) by (1-Fₛ) (S130). The noise disentanglement module 120 may obtain Gaussian noise (z_{g}) by applying IDFT_{3D} to Gaussian noise in the frequency domain.

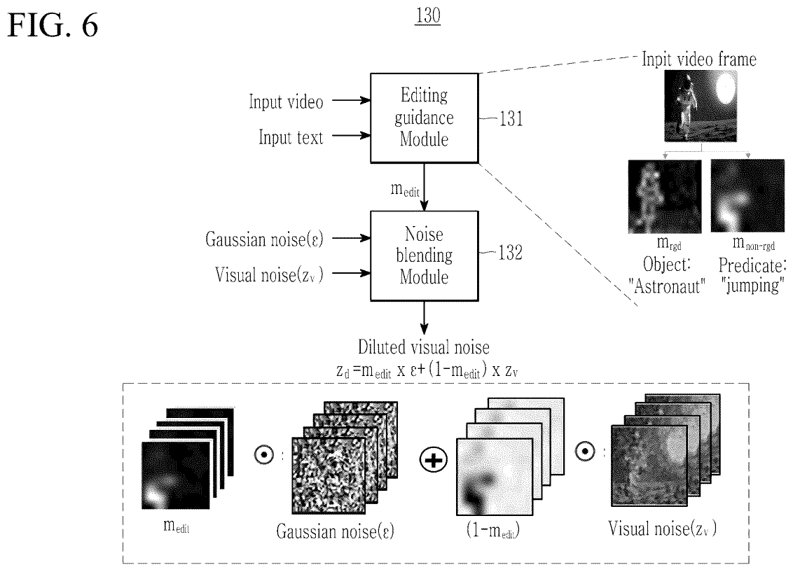

FIG. 6 shows a noise dilution according to an embodiment.

Referring to FIG. 6, the noise dilution module 130 may include an editing guidance module 131 for determining an editing region in the input video that requires editing, and a noise blending module 132.

The editing guidance module 131 may use input text and an input video to determine the editing region in the input video that requires editing by the input text, and may generate an editing guidance mask m_{edit} guiding the editing region. For example, if the input text is ‘Astronaut is jumping’, the editing guidance module 131 may select the editing reference words, ‘astronaut’ and ‘jump’, from the input text and may generate an editing guidance mask for the editing reference words.

In the case of the non-rigid editing by input text, movement/posture modification is required by the predicate of ‘jumping’, but general object segmentation models have limitations in identifying the non-rigid editing regions due to noun-based detection. Therefore, the editing guidance module 131 may determine the editing region using the attention map obtained through cross-attention between the input text and the input video. The editing guidance module 131 may select an editing reference word, for example, ‘jumping’, from the input text and may obtain word features of the editing reference word. The editing guidance module 131 may obtain video features including a video length (L), the number of grids into which the video is divided (P), and a dimension (D). The editing guidance module 131 may obtain an attention map including similarity information at the grid level by multiplying video features and word features (cosine product). That is, regions similar to the editing reference words in the video may be expressed as the attention map.

Among the words in the input text, there are editing reference words that require structure changes and words that do not. For example, if the editing reference word is a noun or adjective, the attention map m_{rgd} provided from a down block of UNet may be used to provide a clear boundary of the editing object (astronaut) for rigid modification. If the editing reference word is a predicate, the blurred attention map m_{non-rgd} provided from an intermediate block of UNet may be used to provide a non-rigid editing region. The m_{rgd} may be referred to as a rigid editing guidance mask that does not require visual structure changes, and m_{non-rgd} may be referred to as a non-rigid editing guidance mask that requires visual structure changes.

The editing guidance module 131 may adjust the size of the attention maps to fit a latent space (W×H) and may generate a final editing guidance mask m_{edit} by combining the editing guidance masks obtained for respective words as in Equation 6. The editing guidance module 131 may determine the importance of rigid editing or non-rigid editing in video editing based on the input text, and may adjust the influence of the respective editing guidance masks by α and β determined based on the same.

$${m}_{edit} = α \times {m}_{rgd} + β \times {m}_{non - rgd} ∈ {R}^{W \times H \times L} \qquad ( Equation 6 )$$

Here, α and β are hyperparameters between 0 and 1 that control the influence of the editing guidance mask. The closer it is to 1, the more Gaussian noise increases and the more the influence of the input video may be suppressed through noise mixing. α enables effective editing within the visual structure, and β supports dynamic editing beyond the visual structure.

The noise blending module 132 may dilute the visual noise in the editing region by adding Gaussian noise (ε) to the editing region specified by the editing guidance mask m_{edit}. Gaussian noise (ε) is added to the editing region identified by the editing guidance mask m_{edit}, and visual noise is added to the non-editing region, so that diluted visual noise z_{d} may be output.

The diluted visual noise (z_{d}) is added to the Gaussian noise (z_{g}) separated from the initial latent noise (z) to synthesize the dilutional latent noise (z*). Instead of the initial latent noise (z), diluted dilutional latent noise (z*), in which the visual noise of the non-rigid editing region is diluted, is input to the editing module 140.

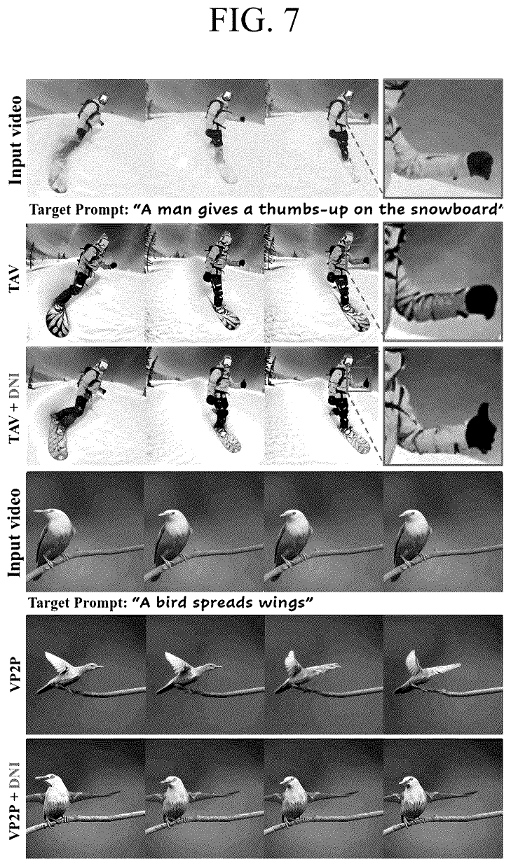

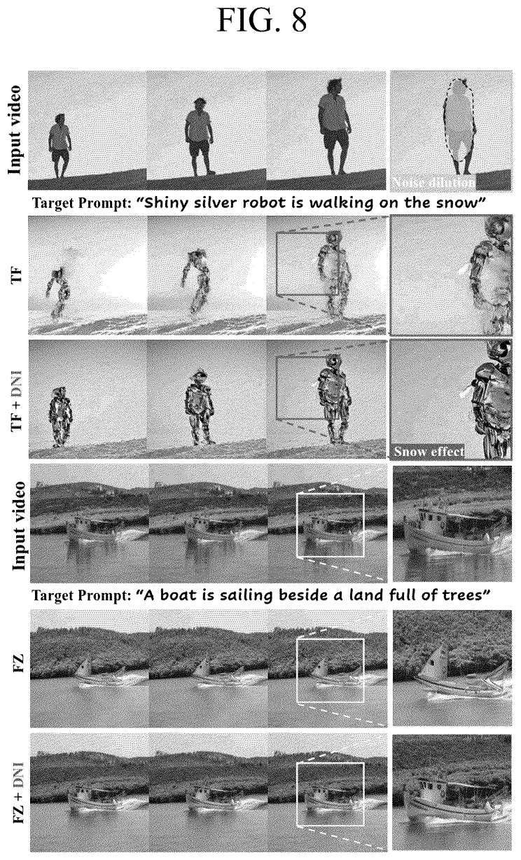

FIG. 7 shows non-rigid editing result to which a dilutional noise initialization (DNI) framework according to an embodiment is applied, and FIG. 8 shows rigid editing result to which a dilutional noise initialization (DNI) framework according to an embodiment is applied.

Referring to FIG. 7, the results of applying the dilutional noise initialization (DNI) framework including the noise disentanglement module 120 and the noise dilution module 130 to recent editing systems, Tune-A-Video (TAV) and Video-P2P (VP2P), will now be described.

When the target prompt for the input video is “A man gives a thumps-up on the snowboard,” it may be confirmed that motion editing, such as a thumbs-up motion, is selectively performed based on the visibility of the snowboarder's hand in the edited video (TAV+DNI) with the dilutional noise initialization (DNI) framework applied to TAV, compared to the edited video of TAV. The dilutional noise initialization (DNI) framework may improve the editing performance of TAV by recognizing the editing region (snowboarder's hand) based on the editing reference words ‘gives’ and ‘thumbs-up’ and providing dilutional latent noise obtained may diluting the visual noise of the editing region, to the editing process of TAV.

When the target prompt for the input video is “A bird spreads wings,” it is found that motion editing, such as a bird spreading its wings, is performed in the edited video (VP2P+DNI) using the dilutional noise initialization (DNI) framework applied to VP2P, compared to the edited video of VP2P (where the trees in the original video and the modified wings are improperly fused). The dilutional noise initialization (DNI) framework may improve the editing performance of VP2P by recognizing the bird wing region as the editing region based on the editing reference words ‘spreads’ and ‘wings’ and providing dilutional latent noise obtained by diluting the visual noise of the editing region to the editing process of VP2P.

As described, it may be found that non-rigid editing performance for object motion may be improved by applying the dilutional noise initialization (DNI) framework to the existing editing system.

The results of applying the dilutional noise initialization (DNI) framework including the noise disentanglement module 120 and the noise dilution module 130 to recent editing systems, TokenFlow (TF) and FateZero (FZ) will now be described with reference to FIG. 8.

Regarding the rigid editing where the target prompt for the input video is “Shiny silver robot is walking on the now,” compared to the edited video of TF, it is confirmed that the edited video (TF+DNI) with the dilutional noise initialization (DNI) framework applied to TF not only changes the human appearance to a robot, but also adds the effect of snow falling in the sky. If a noise diluting region is visualized in the input frame, it is found that the correction range exceeds a predetermined initial boundary. This indicates that the editing based on dilutional latent noise is smoothly connected to the peripheral area, so that the editing effect naturally extends to the periphery, improving the overall effect of editing. Here, the editing reference words are ‘shiny’, ‘silver’, ‘robot’, and ‘snow’.

The rigid editing where the target prompt for the input video is “A boat is sailing beside a land full of trees,” is well performed in the edited video (FZ+DNI) with the dilutional noise initialization (DNI) framework applied to FZ, compared to the edited video of FZ. Here, the editing reference words are ‘land’ and ‘trees’.

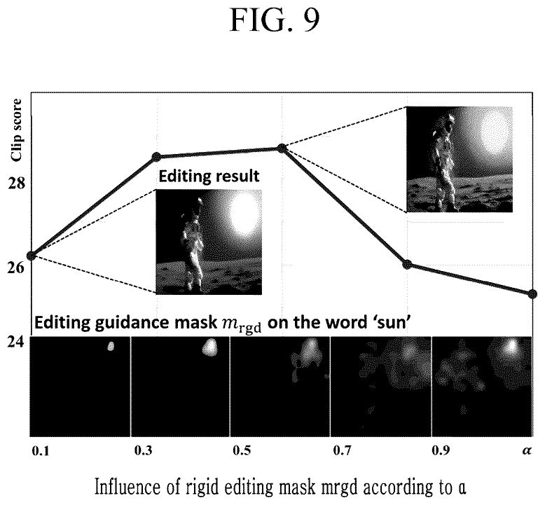

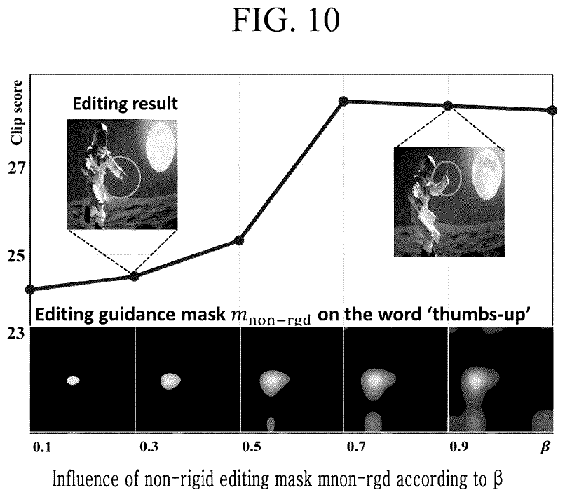

FIG. 9 and FIG. 10 show text alignment sensitivity analysis caused by an editing guidance mask according to an embodiment.

Referring to FIG. 9 and FIG. 10, the editing guidance mask m_{edit} is generated by adjusting the influence of the rigid editing guidance mask m_{rgd} and the non-rigid editing guidance mask m_{non-rgd}, as shown in Equation 6. α enables effective editing within the visual structure, and β supports dynamic editing beyond the visual structure.

The rigid editing for the input text “Astronaut walks through red sunset” will now be described with reference to FIG. 9. ‘Red’ and ‘Sunset’ in the input text may be selected as editing reference words and an editing guidance mask may be generated. Regarding the rigid editing guidance mask m_{rgd} for the editing reference word ‘sunset’ while fixing β as 0, it is found that as α increases, the influence of the rigid editing guidance mask increases, and as a result, the editing region expands, and more effects may be added to the video. As described, editing suitability may be improved by appropriate changes of α (e.g., ~0.7).

The non-rigid editing for “Astronaut gives a thumbs-up under the moon” will now be described with reference to FIG. 10. ‘gives’, ‘thumbs-up’, and ‘Astronaut’ in the input text may be selected as editing reference words and an editing guidance mask may be generated. The non-rigid editing may be enhanced through the non-rigid editing guidance mask m_{non-rgd} for the editing reference words ‘gives’ and ‘thumbs-up’. With the influence of the rigid editing guidance mask fixed at α=0.2, as β increases, the influence of the non-rigid editing guidance mask increases, and as a result, the non-rigid editing region expands. It is confirmed that ‘thumbs-up’, which was not synthesized at β=0.3, is synthesized at β=0.9.

As described, as the noise diluting region is expanded by expanding the non-rigid editing region, the visual structure of the input video is alleviated, allowing the motion corresponding to the input text (e.g., thumbs-up motion) to be freely synthesized from the original motion of the object (e.g., walking motion).

The editing guidance mask m_{edit} is generated by appropriately combining the rigid editing guidance mask m_{rgd} and the non-rigid editing guidance mask m_{non-rgd}, and the quality of the edited video may be determined depending on the hyperparameters α and β.

The editing guidance module 131 may determine the importance of the rigid editing or the non-rigid editing based on the input text, and may adjust the influence of the editing guidance mask based on α and β determined based on the same. For example, a stable editing effect is guaranteed when 0.3<α<0.7 for rigid editing and β>0.6 for non-rigid editing, so α and β may be determined based on the editing properties required in the input text.

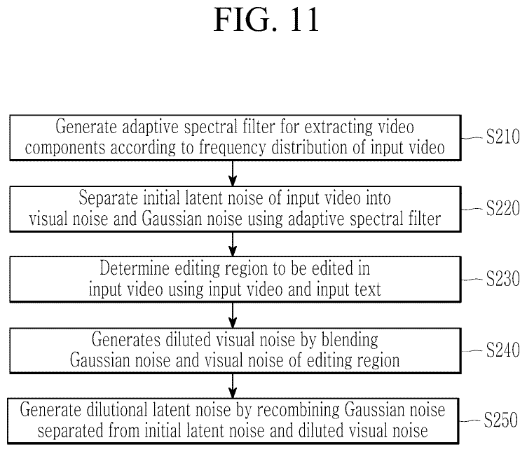

FIG. 11 shows a flowchart on a noise dilution method according to an embodiment.

Referring to FIG. 11, a device 100 may generate an adaptive spectral filter for extracting video components according to the frequency distribution of the input video (S210). The device 100 may obtain the frequency distribution of the input video through the discrete Fourier transform (DTF) and may generate an adaptive spectral filter by normalizing the frequency distribution of the input video to a value between 0 and 1.

The device 100 separates the initial latent noise of the input video into visual noise and Gaussian noise using the adaptive spectral filter (S220). The initial latent noise may be generated by injecting Gaussian noise into the input video. The initial latent noise may be obtained in the forward process of diffusion model-based video editing.

The device 100 may determine an editing region to be edited in the input video using the input video and the input text (S230). The editing region may be determined using the semantic relationship or similarity between the input video and the input text, and may be determined, for example, by using the attention map obtained from the cross-attention model. The attention map between the input text and input video may be used as an editing guidance mask to guide the editing region. The editing guidance mask may be generated for each editing reference word extracted from the input text, and the editing guidance masks of the entire editing reference words may be combined to generate an editing guidance mask guiding the editing region. For example, the attention map provided from the down block of UNet may be used as a rigid editing guidance mask for nouns or adjective words, and the blurred attention map provided from the middle block of UNet may be used as a non-rigid editing guidance mask for predicate words. The device 100 may adjust the influence of the rigid editing guidance mask and the non-rigid editing guidance mask according to the editing properties (rigid editing or non-rigid editing) determined by the input text, and may combine the same.

The device 100 generates diluted visual noise by blending Gaussian noise and the visual noise of the editing region (S240). Diluted visual noise may be generated by blending Gaussian noise added to the editing region through the editing region mask and visual noise added to the non-editing region through the non-editing region mask. This allows dynamic modification of the editing region while guaranteeing video quality by the visual components in the non-editing region.

The device 100 generates dilutional latent noise by recombining Gaussian noise separated from the initial latent noise and diluted visual noise (S250). The dilutional latent noise may be provided as a backward process in diffusion model-based video editing. An edited video corresponding to the input text may be generated by denoising the dilutional latent noise.

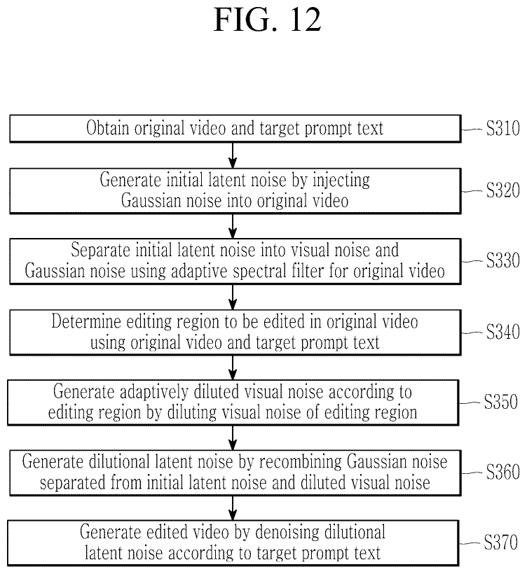

FIG. 12 shows a flowchart on a noise dilution-based video editing method according to an embodiment.

Referring to FIG. 12, the device 100 obtains the original video and target prompt text (S310).

The device 100 generates initial latent noise by injecting Gaussian noise into the original video (S320).

The device 100 separates initial latent noise into visual noise and Gaussian noise using an adaptive spectral filter for the original video (S330).

The device 100 determines the editing region to be edited in the original video using the original video and target prompt text (S340). The editing region may be determined through the attention map obtained based on cross-attention between the target prompt text and the original video. The editing region may be guided by the editing guidance mask. The editing guidance mask may be generated by summing editing guidance masks obtained based on the editing reference words, and the device 100 may sum the same by adjusting the influence of the rigid editing guidance mask and the non-rigid editing guidance mask according to the editing property (rigid editing or non-rigid editing).

The device 100 generates adaptively diluted visual noise according to the editing region by diluting visual noise of the editing region (S350). The diluted visual noise may be generated by blending Gaussian noise added to the editing region through the editing region mask and visual noise added to the non-editing region through the non-editing region mask. This allows dynamic modification of the editing region while guaranteeing video quality by the visual components in the non-editing region.

The device 100 generates dilutional latent noise by recombining the Gaussian noise separated from the initial latent noise and the diluted visual noise (S360).

The device 100 generates edited video by denoising the dilutional latent noise according to the target prompt text (S370).

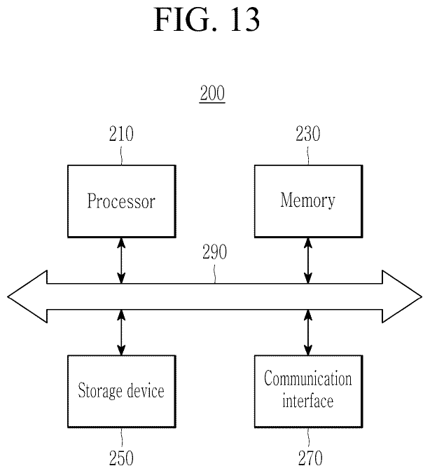

FIG. 13 shows a hardware schematic diagram on a computing device according to an embodiment.

Referring to FIG. 13, the video editing device 100 may be a computing device 200 including a memory storing instructions for performing the present disclosure, and at least one processor configured to execute the instructions to perform the method of the present disclosure.

The computing device 200 may include one or more processors 210, memory 230 for loading a computer program executed by the processor 210, a storage device 250 for storing the computer program and various data, a communication interface 270, and a bus 290 for connecting them. The computing device 200 may further include various components. The computer program, when loaded into the memory 230, may include instructions causing the processor 210 to perform the methods/operations according to various embodiments of the present disclosure. That is, the processor 210 may perform the methods/operations according to various embodiments of the present disclosure by executing the instructions. The instructions are a series of computer-readable instructions grouped by reference to functions, which are components of the computer program and are executed by the processor.

The processor 210 controls general operations of the components of the computing device 200. The processor 210 may be configured to include at least one of a central processing unit (CPU), a micro processor unit (MPU), a micro controller unit (MCU), a graphics processing unit (GPU), or any other types of processors known in the art of the present disclosure. The processor 210 may perform operations for at least one application or program to perform the methods/operations according to various embodiments of the present disclosure.

The memory 230 stores various data, instructions, and/or information. The memory 230 may load one or more programs from the storage device 250 to perform the methods/operations according to various embodiments of the present disclosure. The memory 230 may be implemented as a volatile memory such as the RAM, but the technical scope of the present disclosure is not limited thereto.

The storage device 250 may store programs non-temporarily. The storage device 250 may include a non-volatile memory such as a read-only memory (ROM), an erasable programmable ROM (EPROM), an electrically erasable programmable ROM (EEPROM), or a flash memory, a hard disk, a removable disk, or any other form of computer-readable recording medium well known in the art to which the present disclosure pertains.

The communication interface 270 supports wired/wireless communication of the computing device 200. For this purpose, the communication interface 270 may be configured to include a communication module well known in the technical field of the present disclosure.

The bus 290 provides communication functions between components of the computing device 200. The bus 290 may be implemented as various types of buses, such as an address bus, a data bus, and a control bus.

Thus, according to the present disclosure, noise dilution may be used to generate video aligned to the target prompt without any constraints on the visual structure.

According to the present disclosure, non-rigid editing, such as motion changes, may be performed precisely and dynamically, and rigid editing that maintains visual structure, such as style transfer, may be performed much more naturally and creatively.

According to the present disclosure, users may generate edited videos as they wish.

The dilutional noise initialization (DNI) framework of the present disclosure may be applied to various video editing systems to improve the performance of existing video editing systems.

The embodiment described above is not implemented only through the device and method, but may also be implemented through a program realizing functions corresponding to the configuration of an embodiment or a recording medium in which the program is recorded.

Although the embodiment has been described in detail, the scope of the present disclosure is not limited thereto, and various modifications and improvements made by a person of an ordinary skill in the art using the basic concept of the present disclosure defined in the following claims also fall within the scope of the present disclosure.

What is claimed is:

1. A method for video editing based on noise dilution by at least one processor, comprising:
separating initial latent noise of an input video into visual noise and Gaussian noise using an adaptive spectral filter designed to extract video components according to a frequency distribution of the input video;
determining an editing region to be edited in the input video using the input video and input text;
generating diluted visual noise by blending Gaussian noise and the visual noise of the editing region; and
generating dilutional latent noise by recombining Gaussian noise separated from the initial latent noise and the diluted visual noise.

2. The method of claim 1, wherein the editing region is determined by an editing guidance mask obtained through cross-attention between the input text and the input video.

3. The method of claim 2, wherein the determining the editing region comprises:
generating editing guidance masks for editing reference words extracted from the input text; and
generating the editing guidance mask for guiding the editing region by combining the editing guidance masks of the entire editing reference words.

4. The method of claim 3, wherein the determining the editing region comprises
combining the editing guidance masks of the entire editing reference words by adjusting influences of a rigid editing mask and a non-rigid editing mask.

5. The method of claim 1, wherein the generating the diluted visual noise comprises
generating the diluted visual noise by the Gaussian noise blending for blending Gaussian noise added to the editing region and visual noise added to the non-editing region.

6. The method of claim 1, further comprising:
generating an edited video by denoising the dilutional latent noise according to the input text.

7. The method of claim 1, further comprising:
providing the dilutional latent noise to a backward process of diffusion model-based video editing.

8. A method for video editing based on noise dilution by at least one processor, comprising:
obtaining an original video and target prompt text;
generating initial latent noise by injecting Gaussian noise into the original video;
separating the initial latent noise into visual noise and Gaussian noise using an adaptive spectral filter of the original video;
determining an editing region to be edited in the original video using the original video and the target prompt text;
generating diluted visual noise by diluting visual noise of the editing region;
generating dilutional latent noise by recombining Gaussian noise separated from the initial latent noise and the diluted visual noise; and
generating an edited video by denoising the dilutional latent noise according to the target prompt text.

9. The method of claim 8, wherein the adaptive spectral filter is implemented to extract video components according to frequency distribution of the original video.

10. The method of claim 8, wherein the editing region is determined by the editing guidance mask obtained through the cross-attention between the target prompt text and the original video.

11. The method of claim 10, wherein the determining the editing region comprises:
generating editing guidance masks for editing reference words extracted from the target prompt text; and
generating the editing guidance mask for guiding the editing region by combining the editing guidance masks of the entire editing reference words.

12. The method of claim 11, wherein the determining the editing region comprises
combining the editing guidance masks of the entire editing reference words by adjusting influences of a rigid editing mask and a non-rigid editing mask.

13. The method of claim 8, wherein the generating the diluted visual noise comprises
generating the diluted visual noise by diluting visual noise of the editing region according to a blending of Gaussian noise and maintaining visual noise of the non-editing region.

14. A device comprising:
at least one memory; and
at least one processor for performing instructions stored in the at least one memory,
wherein the processor is configured to:
separate initial latent noise of the input video into visual noise and Gaussian noise using an adaptive spectral filter designed to extract video components according to frequency distribution of an input video;
determine an editing region to be edited in the input video using the input video and input text;
generate diluted visual noise by blending Gaussian noise and the visual noise of the editing region; and
generate dilutional latent noise by recombining Gaussian noise separated from the initial latent noise and the diluted visual noise.

15. A computer program stored in a computer-readable storage medium, comprising instructions for causing at least one processor to execute to:
separate initial latent noise of an input video into visual noise and Gaussian noise using an adaptive spectral filter for extracting video components according to frequency distribution of the input video;
determine an editing region to be edited in the input video using the input video and input text;
generate diluted visual noise by blending Gaussian noise and the visual noise of the editing region; and
generate dilutional latent noise by recombining Gaussian noise separated from the initial latent noise and the diluted visual noise.
